(19) United States
(12) Patent Application Publication
(10) Pub. No.: US 2026/0058409 A1
(43) Pub. Date: Feb. 26, 2026

(54) VEHICLE CHARGING INLET WITH CHARGING CONNECTOR LOCKING FUNCTION

(71) Applicants: Hyundai Motor Company, Seoul (KR); Kia Corporation, Seoul (KR); Korea Electric Terminal Co., Ltd., Incheon (KR)

(72) Inventors: Yun-Jae Jung, Hwaseong-si (KR); Jae-Hyung Ma, Siheung-si (KR); Jae-Yeob Park, Gunpo-si (KR)

(21) Appl. No.: 19/230,746

(22) Filed: Jun. 6, 2025

(30) Foreign Application Priority Data
Aug. 22, 2024 (KR) 10-2024-0112512

(51) Int. Cl. H01R 13/639; B60L 53/16

(52) U.S. Cl. CPC H01R 13/639; B60L 53/16; H01R 2201/26

(57) ABSTRACT

For a vehicle charging inlet with a charging connector locking function, the vehicle charging inlet can include a casing, an actuator installed in the casing, and a locking rod having a first length, installed in the casing, and configured to be rectilinearly moved by an operation of the actuator, and the vehicle charging inlet is configured such that based on a charging connector being inserted into the vehicle charging inlet, the actuator moves the locking rod toward the charging connector, an end of the locking rod can be inserted into the charging connector, and the charging connector can be locked.

### CROSS-REFERENCE TO RELATED APPLICATIONS

This application claims priority to Korean Patent Application No. 10-2024-0112512, filed on Aug. 22, 2024, which is incorporated herein by reference in its entirety.

### TECHNICAL FIELD

The present disclosure relates to a vehicle charging inlet with a charging connector locking function.

### BACKGROUND

An electric vehicle is equipped with a charging inlet configured to charge a high-voltage battery, which is mounted in the vehicle, by receiving power from the outside.

In order to charge the electric vehicle, a charging connector connected to a charger is connected to the charging inlet, such that power is supplied from the charger to the electric vehicle, and the battery is charged.

A locking structure is applied to prevent the charging connector from separating from the charging inlet in the state in which the charging connector is connected to the charging inlet and the battery is charged.

For example, a rod rotatably provided in the charging inlet operates a locker provided on the charging connector, thereby operating the locker.

In this structure, the rod and the locker need to be operated respectively relative to the charging inlet and the charging connector, which inevitably complicates the structure.

### SUMMARY

The present disclosure relates to a vehicle charging inlet with a charging connector locking function, and the vehicle charging inlet can be capable of restraining a charging connector to prevent the separation of the charging connector during a charging process.

An embodiment of the present disclosure can provide a vehicle charging inlet with a charging connector locking function, and such vehicle charging inlet can have a simple structure and can be capable of maintaining a securely locked state of a charging connector.

A vehicle charging inlet with a charging connector locking function according to an example embodiment of the present disclosure can include: a casing; an actuator installed in the casing; and a locking rod having a first length, installed in the casing, and configured to be rectilinearly movable by an operation of the actuator, such that when a charging connector is inserted, the actuator moves the locking rod toward the charging connector, an end of the locking rod is inserted into the charging connector, and the charging connector is locked.

A locking groove may be formed by a first depth in an outer surface of the charging connector, and the end of the locking rod may be inserted into the locking groove.

The locking rod may include: an operation part configured to be rectilinearly moved by the actuator; an extension rod part inserted into the operation part and extending downward from the operation part; and a locking part fastened to a lower end of the extension rod part and fitted with the charging connector to lock the charging connector.

The operation part may be made of a plastic material, the extension rod part may be made of a steel material, and the operation part may be formed by injection molding in a state in which the extension rod part is inserted.

A lower portion of the extension rod part and an upper portion of the locking part may be fitted with each other, and a fixing pin may penetrate the lower portion of the extension rod part, an upper portion of the locking part, and an upper portion of the extension rod part, such that the extension rod part and the locking part are fastened.

At least one power transmission member may be installed between the actuator and the operation part and transmit driving power of the actuator to the operation part.

The power transmission member may be an operation gear including: an input gear part to which the driving power of the actuator is inputted; a screw screw-coupled to the operation part and configured to move the operation part rectilinearly; and a shaft integrated with the input gear part and the screw.

The operation part may include: a body; and a nut portion screw-coupled to the screw.

A holder may be provided in the casing, penetrated by the operation part, and configured to support a periphery of the operation part, and the operation part may have a sealing portion configured to adjoin an inner surface of the holder and seal a portion between the locking rod and the casing when the locking rod rectilinearly moves.

The sealing portion may have a second length from a bottom surface of the operation part.

A guide may be formed on an outer surface of the operation part and guide the rectilinear motion of the locking rod.

The extension rod part may include: a fixed portion provided in the operation part and fixed to the operation part; and an extension portion extending from the fixed portion and fastened to the locking part.

According to an embodiment of a vehicle charging inlet with a charging connector locking function of the present disclosure configured as described above, the charging connector can be locked or unlocked by rectilinearly moving only the locking rod in the charging inlet, such that the locking structure between the charging inlet and the charging connector is simplified.

In an embodiment of the present disclosure, because the locking structure can be simplified as described above, the required components can be also simplified, and the operational reliability can be also improved.

In an embodiment of the present disclosure, even though the size of the charging inlet can vary depending on the specifications, packaging, and the like of the vehicle, the charging inlet of modified specifications may be manufactured by using a locking rod having different lengths, such that the components, except for the locking rod, may be commonized.

### BRIEF DESCRIPTION OF THE DRAWINGS

FIG. 1 is a cross-sectional view illustrating a state in which a vehicle charging inlet with a charging connector locking function according to an embodiment of the present disclosure unlocks a charging plug.

FIG. 2 is a perspective view illustrating a locking rod of a vehicle charging inlet with a charging connector locking function according to an embodiment of the present disclosure.

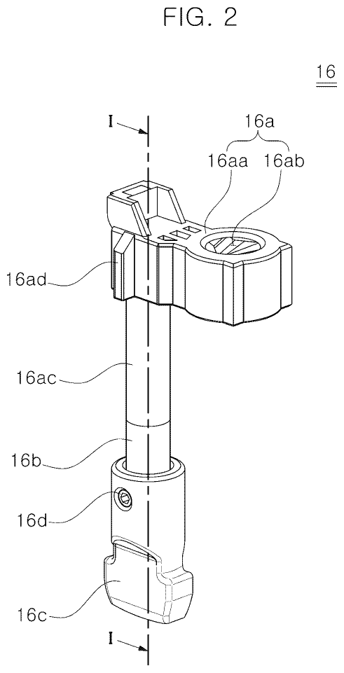

FIG. 3 is a cross-sectional view illustrating a locking rod of a vehicle charging inlet with a charging connector locking function according to an embodiment of the present disclosure.

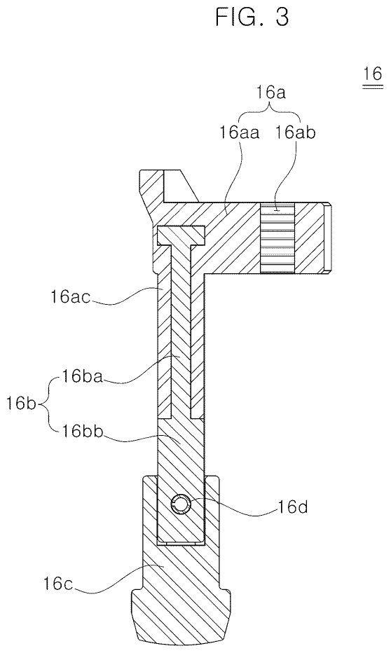

FIG. 4 is a perspective view illustrating a state in which a locking rod is coupled to an operation gear in a vehicle charging inlet with a charging connector locking function according to an embodiment of the present disclosure.

FIG. 5 is a cross-sectional view illustrating a state in which a vehicle charging inlet with a charging connector locking function according to an embodiment of the present disclosure locks the charging plug.

### DETAILED DESCRIPTION OF ILLUSTRATIVE EMBODIMENTS

Hereinafter, example embodiments of the present disclosure will be described in detail with reference to the accompanying drawings, and because these embodiments, as examples, may be implemented in various different forms by those skilled in the art to which the present disclosure pertains, the present disclosure is not necessarily limited to the example embodiments described herein.

Hereinafter, a vehicle charging inlet with a charging connector locking function according to an embodiment of the present disclosure will be described in detail with reference to the accompanying drawings.

A vehicle charging inlet 10 with a charging connector locking function according to an embodiment of the present disclosure can include a casing 11, an actuator 13 installed in the casing 11, and a locking rod 16 having a set, selected, or predetermined length, installed in the casing 11, and configured to be rectilinearly moved by an operation of the actuator 13. When a charging connector 20 is inserted into the vehicle charging inlet, the actuator 13 moves the locking rod 16 toward the charging connector 20, an end of the locking rod 16 is inserted into the charging connector 20, and the charging connector 20 is locked.

The casing 11 can define an external shape of a charging inlet 10, and constituent elements to be described below can be accommodated in the casing 11.

The actuator 13 can be installed in the casing 11. An installation part 12 can be formed in the casing 11 and can have a set, selected, or predetermined space in which the actuator 13, an operation gear 14, and the like may be installed. The actuator 13 can be installed in the installation part 12 of the casing 11.

The actuator 13 may be a drive motor 13 configured to output driving power when power is applied.

A power transmission member 14 can be installed in the installation part 12 and transmits a rotational force of the drive motor 13 to the locking rod 16. The power transmission member 14 may be provided as a gear. At least one gear 14 can be installed in the casing 11. The gear 14 can convert the driving power of the drive motor 13 and transmit the converted driving power to the locking rod 16.

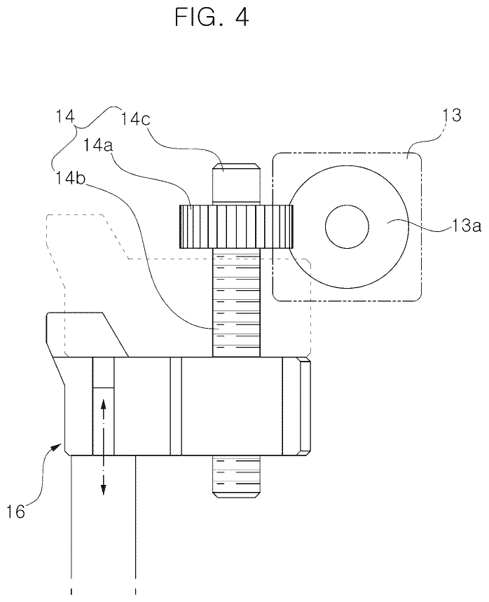

According to a specific example of the power transmission member 14, the power transmission member 14 may be provided as the operation gear 14, as illustrated in FIG. 4. The power transmission member is not necessarily limited thereto. A larger number of gear trains may be provided.

The operation gear 14 can include an input gear part 14a to which the rotational force of the actuator, that is the drive motor, 13 can be inputted, a screw 14b can be configured to rectilinearly move the locking rod 16, and a shaft 14c can be configured to allow the operation gear 14 to be installed in the casing 11. The input gear part 14a can engage with the drive motor 13 and receives the driving power from the drive motor 13. For example, if a driving gear 13a is installed on a rotary shaft of the drive motor 13, the input gear part 14a can engage with the driving gear 13a, such that the operation gear 14 also rotates when the drive motor 13 rotates. The operation gear 14 can be screw-coupled to the locking rod 16, and the locking rod 16 can rectilinearly move as the screw 14b rotates. A motion direction of the locking rod 16 can be determined depending on the rotation direction of the screw 14b. The shaft 14c can be integrated with the input gear part 14a and the screw 14b. The shaft 14c can be rotatably installed in the casing 11, such that the operation gear 14 can be rotatably installed in the casing 11.

The locking rod 16 can have a set, selected, or predetermined length and can be installed in the casing 11 so as to be rectilinearly movable. The locking rod 16 can be rectilinearly moved by the operation of the drive motor 13. The end of the locking rod 16 can be fitted with the charging connector 20 inserted into the charging inlet 10 by the rectilinear motion of the locking rod 16, such that the charging connector 20 can be locked.

The locking rod 16 can include an operation part 16a configured to be rectilinearly moved by the actuator 13, an extension rod part 16b inserted into the operation part 16a and extending downward from the operation part 16a, and a locking part 16c fastened to a lower end of the extension rod part 16b, fitted with the charging connector 20, and configured to lock the charging connector 20.

The operation part 16a can be rectilinearly moved by the drive motor 13, such that the operation part 16a moves the locking rod 16 rectilinearly. The operation part 16a can include a body 16aa, and a nut portion 16ab formed at one side of the body 16aa and screw-coupled to the screw 14b. Therefore, the operation part 16a can be rectilinearly moved by the rotation of the operation gear 14. The motion direction of the operation part 16a can be determined depending on the rotation direction of the operation gear 14.

The operation part 16a can be configured such that a periphery of the locking rod 16 can be supported in the casing 11 by a holder 15. The operation part 16a can have a sealing portion 16ac provided below the body 16aa and configured to penetrate the holder 15, and the holder 15 can support the sealing portion 16ac. The sealing portion 16ac can be in contact with the holder 15 and seal a portion between the locking rod 16 and the casing 11. The sealing portion 16ac can have a set, selected, or predetermined length from a bottom surface of the operation part 16a, i.e., a bottom surface of the body 16aa. Because the sealing portion 16ac can have a set, selected, or predetermined length, the holder 15 can contact the sealing portion 16ac even though the locking rod 16 moves. Because the contact between the locking rod 16 and the casing 11 can be implemented by the contact between the sealing portion 16ac and the holder 15, the locking rod 16 and the casing 11 can contact each other with a set, selected, or predetermined frictional coefficient, such that a side effect on a friction portion is not caused by a change in the frictional coefficient.

A guide 16ad, which can guide the rectilinear motion of the locking rod 16, may be provided on an outer surface of the operation part 16a. The guide 16ad can be formed in a rectilinear motion direction of the locking rod 16 and can guide a sliding motion of the operation part 16a.

The extension rod part 16b can include a fixed portion 16ba fixed to the operation part 16a and disposed in the operation part 16a, and an extension portion 16bb can be extending from the fixed portion 16ba and fastened to the locking part 16c.

The fixed portion 16ba can be fixed in the operation part 16a. The fixed portion 16ba may have a ‘T’ shape to maintain a state in which the fixed portion 16ba is fixed in the operation part 16a.

The extension portion 16bb can extend from the fixed portion 16ba, and a lower end of the extension portion 16bb can be fastened to the locking part 16c, which will be described below. The fixed portion 16ba can be positioned in the operation part 16a without being exposed, and the extension portion 16bb can be exposed to the outside from a lower end of the operation part 16a. The extension portion 16bb can be fastened to the locking part 16c, which can be configured to lock the charging connector 20.

The extension rod part 16b can be integrated with the fixed portion 16ba and the extension portion 16bb and particularly made of a steel material. In comparison with an example in which the operation part 16a can be made of a plastic material, a length of the locking rod 16 may be increased because the extension portion 16bb can be made of steel.

If only a length of the locking rod 16 made of a plastic material, like the operation part 16a, is increased to increase the length of the locking rod 16, rigidity may be degraded by the increase in length of the locking rod 16. However, to increase the length of the locking rod 16, the length of the extension rod part 16b made of a steel material can be increased, instead of the operation part 16a, such that the deterioration in rigidity may be prevented even though the length of the locking rod 16 is increased.

The length of the extension rod part 16b can vary while a size of the operation part 16a of the locking rod 16 can be uniformly maintained, such that the length of the locking rod 16 may be determined depending on various specifications. For example, even though a size of the charging inlet 10 can vary depending on the specifications of the vehicle, the other constituent elements, except for the locking rod 16, may be used in common or modular.

In particular, even though the length of the locking rod 16 can vary, the length of the operation part 16a can remain constant, such that a portion of the locking rod 16, which contacts the holder 15, can be always the sealing portion 16ac. Therefore, even though the locking rod 16 rectilinearly moves, the locking rod 16 can be in contact with the holder 15 by use of the sealing portion 16ac.

Because the operation part 16a and the extension rod part 16b can be respectively made of plastic and steel, the operation part 16a and the extension rod part 16b may be manufactured by an insert-injection molding method that inserts the extension rod part 16b and forms the operation part 16a by injection molding around the extension rod part 16b.

An upper portion of the locking part 16c can be fastened to a lower portion of the extension rod part 16b. The lower portion of the extension rod part 16b and the upper portion of the locking part 16c can be fitted with each other, and a fixing pin 16d can penetrate the extension rod part 16b and the locking part 16c, such that the locking part 16c and the extension rod part 16b are fastened using the fixing pin 16d.

The locking part 16c can be inserted into an outer side of the charging connector 20 and restrict a movement of the charging connector 20 when the locking rod 16 rectilinearly moves to lock the charging connector 20.

The charging connector 20 can include a housing 21, and a terminal 22 provided in the housing 21 and configured as a conductor. A locking groove 21a can be formed by a set, selected, or predetermined depth in the housing 21 so that the locking part 16c can be inserted into the locking groove 21a.

Because the locking groove 21a can be formed in the charging connector 20 so as to be concave in a direction perpendicular to a direction in which the charging connector 20 is inserted into the charging inlet 10, the movement of the charging connector 20 can be restricted when the locking part 16c is inserted into the locking groove 21a.

A process in which a vehicle charging inlet with a charging connector locking function according to an embodiment of the present disclosure configured as described above locks or unlocks the charging connector will be described below.

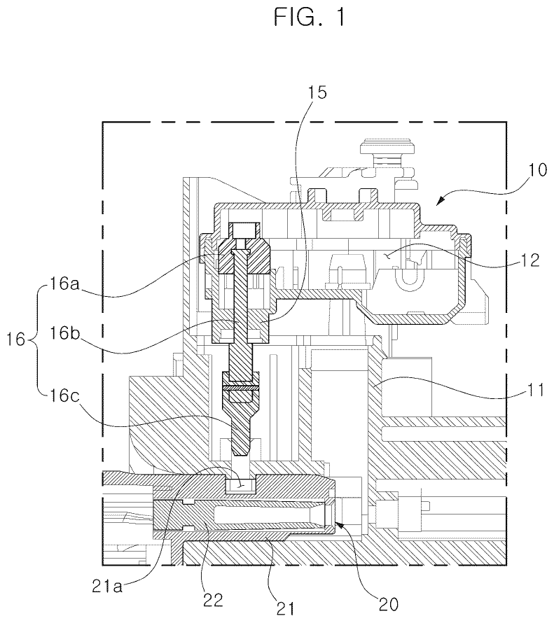

FIG. 1 illustrates a state in which the charging inlet 10 unlocks the charging connector 20.

For example, when the charging connector 20 is inserted into the charging inlet 10 to charge the vehicle, the charging connector 20 can be positioned in a charging port of the charging inlet 10.

When the charging connector 20 is inserted into the charging inlet 10, the terminal of the charging connector 20 and a terminal pin (not illustrated) of the charging inlet 10 can be mechanically connected, but the charging connector 20 and the charging inlet 10 are not yet locked.

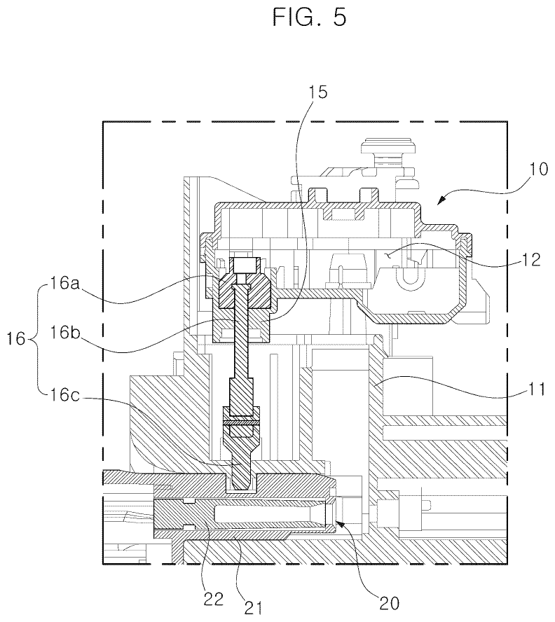

Thereafter, when the charger and the vehicle communicate with each other to charge a battery of the vehicle, the drive motor 13 of the charging inlet 10 can operate. When the drive motor 13 operate, the driving power of the drive motor 13 can be transmitted to the locking rod 16 through the operation gear 14. Therefore, the locking rod 16 can be rectilinearly moved (moved downward in FIGS. 1 and 5) toward the charging connector 20 by a mechanical connection relationship between the operation gear 14 and the locking rod 16, i.e., a screw coupling relationship between the screw 14b and the nut portion 16ab.

When the locking rod 16 is moved maximally, the locking part 16c of the locking rod 16 can be fitted with the locking groove 21a formed in the charging connector 20 (see FIG. 5). The direction in which the locking rod 16 is fitted and the direction in which the charging connector 20 is inserted can be perpendicular to each other, such that the charging connector 20 can be in a locked state without separating from the charging inlet 10.

When power is supplied from the charger in this state, it can be possible to prevent a situation in which the charging connector 20 is inadvertently separated from the charging inlet 10 during the charging process.

In situation in which the charging connector 20 needs to be separated (e.g., as the charging process is completed), the drive motor 13 can rotate so that the locking rod 16 is separated from the charging connector 20. The drive motor 13 can rotate in a direction opposite to the direction in which the drive motor 13 rotated to perform the locking process, such that the locking rod 16 can rectilinearly move (moves upward in FIGS. 1 and 5) in a direction in which the locking rod 16 can be separated from the charging connector 20. When the locking rod 16 is separated from the locking groove 21a, the charging connector 20 is unlocked without constraint to its movement, such that the charging connector 20 may be separated.

What is claimed is:

1. A vehicle charging inlet with a charging connector locking function, the vehicle charging inlet comprising:
a casing;
an actuator installed in the casing; and
a locking rod having a first length, installed in the casing, and configured to be rectilinearly movable by an operation of the actuator,
wherein the vehicle charging inlet is configured such that based on a charging connector being inserted into the vehicle charging inlet, the actuator can move the locking rod toward the charging connector, an end of the locking rod can be inserted into the charging connector, and the charging connector can be locked.

2. The vehicle charging inlet of claim 1, wherein a locking groove with a first depth in an outer surface of the charging connector, and wherein the locking groove is configured to engage with the end of the locking rod being inserted into the locking groove.

3. The vehicle charging inlet of claim 1, wherein the locking rod comprises:
an operation part configured to be rectilinearly moved by the actuator;
an extension rod part inserted into the operation part and extending from the operation part; and
a locking part fastened to a distal end of the extension rod part, wherein the locking part is configured to be fitted with the charging connector to lock the charging connector.

4. The vehicle charging inlet of claim 3, wherein the operation part is made of a plastic material, the extension rod part is made of a steel material, and the operation part is injection molded onto the extension rod part.

5. The vehicle charging inlet of claim 3, further comprising a fixing pin, wherein a distal portion of the extension rod part and an upper portion of the locking part are fitted with each other, and where the fixing pin penetrates the distal portion of the extension rod part and the upper portion of the locking part such that the extension rod part and the locking part are fastened by the fixing pin.

6. The vehicle charging inlet of claim 3, further comprising a power transmission member installed between the actuator and the operation part, wherein the power transmission member is configured to transmit a driving power of the actuator to the operation part.

7. The vehicle charging inlet of claim 6, wherein the power transmission member includes an operation gear comprising:
an input gear part configured to receive the driving power of the actuator being inputted thereto;
a screw screw-coupled to the operation part and configured to move the operation part rectilinearly; and
a shaft integrated with the input gear part and the screw.

8. The vehicle charging inlet of claim 7, wherein the operation part comprises:
a body; and
a nut portion screw-coupled to the screw.

9. The vehicle charging inlet of claim 3, wherein the casing comprises a holder penetrated by the operation part and configured to support a periphery of the operation part, and
wherein the operation part comprises a sealing portion configured to contact an inner surface of the holder and seal a portion between the locking rod and the casing when the locking rod rectilinearly moves.

10. The vehicle charging inlet of claim 9, wherein the sealing portion has a second length from a bottom surface of the operation part.

11. The vehicle charging inlet of claim 3, wherein the operation part comprises a guide on an outer surface of the operation part, wherein the guide is configured to guide a rectilinear motion of the locking rod.

12. The vehicle charging inlet of claim 3, wherein the extension rod part comprises:
a fixed portion provided in the operation part and fixed to the operation part; and
an extension portion extending from the fixed portion and fastened to the locking part.

13. The vehicle charging inlet of claim 12, wherein the fixed portion of the extension rod part includes a T-shaped portion.

14. A vehicle charging inlet comprising:
a casing comprising:
a holder,
an actuator accommodating space, and
a port configured to receive a charging connector therein;
an actuator in the actuator accommodating space;
a power transmission part engaged with the actuator in a first configuration such that the actuator can rotate the power transmission part;
an operation part engaged the power transmission part in a second configuration such that rotation of the power transmission part can rectilinearly move the operation part;
an extension part fixed to and extending from the operation part, wherein a portion of the extension part is supported by the holder of the casing in a third configuration such that the extension part can rectilinearly move relative to the casing in the holder; and
a locking part fixed to a distal end of the extension part, wherein the locking part has a shape configured to engage with a locking groove of the charging connector.

15. The vehicle charging inlet of claim 14, wherein the port extends perpendicular to the extension part in a fourth configuration such that the locking part can be perpendicularly inserted into the locking groove.

16. The vehicle charging inlet of claim 14, wherein the power transmission part comprises a first gear, wherein the actuator comprises a drive motor and a second gear, and wherein the first gear engages with the second gear.

17. The vehicle charging inlet of claim 14, wherein the power transmission part comprises a threaded screw portion, wherein the operation part comprises a threaded nut portion, and wherein the threaded screw portion engages with the threaded nut portion.

18. The vehicle charging inlet of claim 14, further comprising a fixing pin, wherein the locking part is fixed to the distal end of the extension part using the fixing pin, wherein the operation part comprise plastic, wherein the extension part comprises metal, and wherein the extension part comprises a T-shaped end embedded in the operation part.

19. A method of charging a vehicle battery, the method comprising:
inserting a charging connector into a casing of a vehicle charging inlet;
mechanically connecting a charger terminal of the charging connector to a vehicle terminal of the vehicle charging inlet;
operating a drive motor of the vehicle charging inlet in a first rotation direction to turn a power transmission member of the vehicle charging inlet;
rectilinearly moving an operation part of the vehicle charging inlet in a first linear direction by a threaded screw of the power transmission member engaging with a threaded nut of the operation part;
rectilinearly moving a locking pin attached to the operation part via an extension rod part in the first linear direction to insert the locking pin into a locking groove in the charging connector;
locking a position of the charging connector relative to the vehicle charging inlet by an engagement of the locking pin with the locking groove; and
charging the vehicle battery via the charger terminal and the vehicle terminal.

20. The method of claim 19, further comprising:
completing the charging of the vehicle battery;
operating the drive motor of the vehicle charging inlet in a second rotation direction to turn the power transmission member of the vehicle charging inlet, wherein the second rotation direction is opposite the first rotation direction;
rectilinearly moving the operation part of the vehicle charging inlet in a second linear direction by the threaded screw of the power transmission member engaging with the threaded nut of the operation part, wherein the second linear direction is opposite the first linear direction;
rectilinearly moving the locking pin via the extension rod part in the second linear direction to retract the locking pin from the locking groove;
unlocking the charging connector relative to the vehicle charging inlet by disengaging of the locking pin from the locking groove; and
removing the charging connector from the vehicle charging inlet.
